(19) United States
(12) Patent Application Publication
(10) Pub. No.: US 2007/0038584 A1
(43) Pub. Date: Feb. 15, 2007

(54) Method for delivering free gift and advertising

(76) Inventors: Christopher J. Faris, Gloucester, MA (US); Eric McNiff, Gloucester, MA (US); Christopher G. Rowen, Rockport, MA (US)

Correspondence Address: Paul J. Cook, 115 Pine Street, Manchester, MA, 01944, US

(21) Appl. No.: 11/201,808

(22) Filed: Aug. 12, 2005

(51) Int. Cl. G06Q 30/00

(52) U.S. Cl. 705/500

(57) ABSTRACT

Sanitary free gifts are delivered in a sealed container to children located at points of giving frequented by children. The container contains collateral material such as advertisements, coupons or free samples directed to appeal and educate the children, parents or guardians of the children. The delivery system is designed to provide the provider of the collateral material experiences an increase in amounts of business in providing goods and/or services to the children, patents and/or guardians of the child for the supplier of the gifts and a benefit to the suppliers of the collateral material.

### BACKGROUND OF THE INVENTION

This invention relates to a method for distributing advertising, marketing and/or promotional materials through children and/or the parents or guardians of the children such as pediatric patients. More particularly, this invention relates to such a method wherein a pediatric patient is given a gift uncontaminated with microorganisms together with advertising and/or marketing/promotional materials.

A problem at pediatric treatment facilities is the presence of micro-organisms transmitted by the sick pediatric patients to other patients. This problem is particularly acute when the patients handle common toys or entertainment facilities. The reduction or elimination of microorganisms transmitted among pediatric patients in this manner would be desirable. The problem presented by microorganisms is also a problem for children in public places such as restaurants, amusement centers, public transportation such as airlines or the like.

Advertising, marketing and/or promotion of goods and/or services to a particular segment of the population oftentimes is difficult. This problem is exacerbated when a distribution system targeting a particular population segment is unavailable.

Accordingly, it would be desirable to provide a distribution system which provides children such as pediatric patients with a free gift which is substantially microorganism-free. In addition, it would be desirable to provide such a distribution system wherein providers of goods and/or services to children such as pediatric patients and/or the parents or guardians of pediatric patients are able to provide advertising, marketing materials and/or promotional materials. Furthermore, it would be desirable to provide such a distribution system wherein the provider of the gifts earns a profit and the providers of the advertising, marketing materials and/or promotional materials earn a benefit from the use of the distribution system.

### SUMMARY OF THE INVENTION

In accordance with this invention, a distribution system is provided for distributing one or more free gifts substantially free of microorganisms together with advertising, marketing and/or promotional materials to children such as pediatric patients. The free gifts are suitable for use by children and the advertising, marketing and/or promotional materials promote goods and/or services suitable for use by the children and/or the parents or guardians of the children. The gifts and advertising, marketing and/or promotional materials are designed to provide a profit for the suppliers of the gifts and/or promotional materials by virtue of their being distributed through the distribution system.

### DESCRIPTION OF SPECIFIC EMBODIMENTS

The present invention provides a means for safe gift giving to a child such as a restaurant diner, an airline or railroad traveler, a pediatric patient or the like together with advertising, marketing and/or promotional material designed to attract and educate the children and/or parents or guardians of the child. In addition, the method of distributing the gift together with the advertising, marketing and/or promotional material is designed to provide a profit to the supplier of the gift and a benefit to the suppliers of the advertising, marketing and/or promotional material.

In order to safeguard the child against harmful microorganisms, the gift is sanitized and sealed against the atmosphere within a container for the gift such as a plastic bag or other sanitary wrap. Sanitization can be effected in any conventional manner such as exposure to ultraviolet light, heat or the like. Sealing the toy within the container also inactivates any microorganisms present on the sealed toy within a short time period, such as within less than 10 hours after sealing. Representative suitable gifts that can be sanitized include stuffed toy animals, figurines, puzzles, books, games or the like. The gift is presented to the child in the sealed container that can be opened by the child at any desired time.

The sealed container also includes collateral materials such as advertising, marketing and/or promotional material including coupons, free samples or the like. The collateral material is designed to promote goods and/or services and/or to educate the children and/or the parents or guardians of the child receiving the gift. The provider of the gift to the child receives a fee from the provider of the collateral material so that the provider of the gift makes a profit from the gift giving activity. In addition, the provider of the collateral material experiences an increase in amounts of business in providing goods and/or services to the children, parents or guardians of the child. Representative suitable providers of the collateral material include consumer product companies, health insurance providers, pharmaceutical companies, publishers, film production companies, licensors, retailers, toy companies, restaurant chains, public transportation providers or the like.

The sanitary gifts can be distributed through existing distribution channels of the providers of the collateral material or through a distribution channel of the provider of the gifts to the children. In any event, the distribution channel utilized should be capable of delivering the gift to desired points of acceptance which are venues routinely visited by children such as a pediatric medical offices, family medical practitioners offices, restaurants, public transportation providers, amusement parts, motion picture theaters, hotels, schools, daycare facilities, hospitals, retail stores, shopping malls, sports venues, personal care venues such as barber shops or rehabilitation facilities or the like. Previously existing distribution channels are established by previous providers of goods and/or services selectively to the desired points of acceptance.

1. A method for delivering advertising material, marketing material and/or promotional material to a desired segment of consumer which comprises:
providing a free sanitary gift for a child within a container sealed against the atmosphere,
said container including said advertising material, marketing material and/or promotional material,
and distributing said sanitary gift through a distribution channel to a plurality of points of giving of said sanitary gift to a child.

2. The method of claim 1 wherein said points of giving are pediatric treatment facilities.

3. The method of claim 1 wherein said points of giving are restaurants.

4. The method of claim 1 wherein said points of giving are airports or aircraft.

5. The method of claim 1 wherein said points of giving are railroad stations or trains.

6. The method of claim 1 wherein said points of giving are amusement parks.

7. The method of claim 1 wherein said points of giving are theaters.

8. The method of claim 1 wherein said points of giving are sports venues.

9. The method of claim 1 wherein said points of giving are hotels.

10. The method of claim 1 wherein said points of giving are schools.

11. The method of claim 1 wherein said points of giving are daycare facilities.

12. The method of claim 1 wherein said points of giving are hospitals.

13. The method of claim 1 wherein said points of giving are retail stores.

14. The method of claim 1 wherein said points of giving are shopping malls.

15. The method of claim 1 wherein said points of giving are family medical practitioner offices.

16. The method of claim 1 wherein said points of giving are personal care venues.
